(19) United States
(12) Patent Application Publication
(10) Pub. No.: US 2015/0126059 A1
(43) Pub. Date: May 7, 2015

(54) WATERPROOF ASSEMBLY FOR A LIGHT STRING

(71) Applicant: Shandong Neon King Electronics Co., Ltd., SHANDONG PR (CN)

(72) Inventor: QINGEN ZHAO, SHANDONG PR (CN)

(73) Assignee: Shandong Neon King Electronics Co., Ltd., SHANDONG PR (CN)

(21) Appl. No.: 14/072,249

(22) Filed: Nov. 5, 2013

(51) Int. Cl. F21V 23/06

(52) U.S. Cl. CPC F21V 23/06
USPC 439/519

(57) ABSTRACT

A waterproof light string assembly that comprises two ends that join to complete a circuit. The first end comprises an electrical male conducting element encased within a protective nodule. A second end comprises a protruding sheath having a female conducting element disposed therein and a configuration that accepts a portion of the nodule when said male element enters the sheath. The assembly is designed such that electrical elements are protected from ambient matters such as water and provide improved connectivity.

### BACKGROUND

A. Field of Invention

The present invention generally relates to lighting and connections, in particular, the present invention relates to an assembly for a light string that has waterproof characteristics and improved connectivity.

B. Description of the Related Art

Waterproof and or water resistant assemblies for light strings are known. For example, U.S. Pat. No. 6,893,144 (Fan) discloses an assembly, of which reference is incorporated herein. Fan discloses a female connector having two holes (23) that correspond to a male connector having two pins (13) as shown in Fan FIG. 1. Fan identifies Fan FIG. 5 as prior art, which too provides a female connector having two holes (611) that correspond to a male connector having two pins (55). Upon comparison of Fan FIG. 1 with Fan FIG. 5 prior art, it is obvious that Fan merely fuses cited prior art cover (67) to cited prior art shoulder (63) and removes cited prior art threading (671) and (531). Next, to accomplish the goal of Fan FIG. 1, Fan simply adds a cap to the cited prior art first body (51) shown in Fan FIG. 5 and disposes new threading.

Fan (U.S. Pat. No. 6,893,144) and the prior art cited therein, provide same configurations. As a result, the configuration of Fan and the Fan cited prior art are not enough to protect the electrical connection for similar reasons Fan asserts as failure of prior art. Additionally, the pins provided in both Fan and the Fan cited prior art are exposed and capable of being compromised, affecting integrity of electrical connections. The instant invention overcomes deficiencies of prior art and provides an improved waterproof assembly with improved connectivity.

### SUMMARY

The current invention provides an assembly that comprises a first portion having at least one female electrical connection housed within a protective sheath that extends out from an internal base enclosed by an outer casing. A second portion consists of a plug having at least one male electrical connection recessed in a chamber formed therein, that when the male and female portions are combined, the protective sheath surrounds both male and female connections at the same time and encased forming an airtight and waterproof barrier. The resulting connections provide better connectivity and protect the male electrical connections from being damaged.

### BRIEF DESCRIPTION OF THE DRAWINGS

The invention may take physical form in certain parts and arrangement of parts, some embodiments of which will be described in the specification and illustrated in accompanying drawings which form a part hereof, wherein:

FIG. 1 is an exploded perspective view of the assembly;

FIG. 2 is a cross sectional view of the assembly when disconnected ;

FIG. 3 is a cross sectional view of the assembly when connected and showing engagement between male and female components.

### DETAILED DESCRIPTION OF THE INVENTION

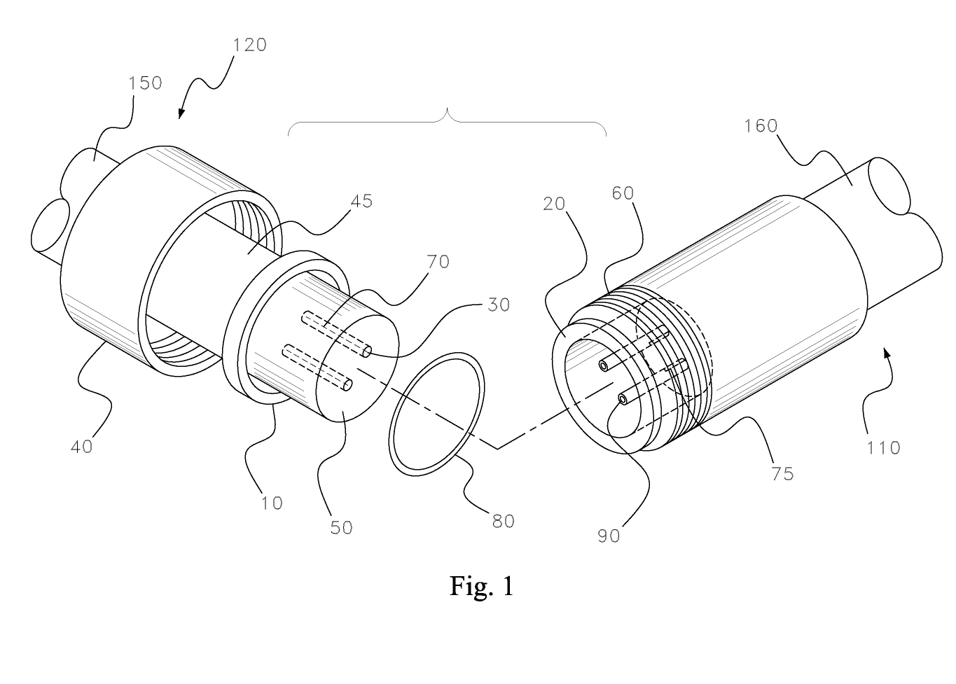

According to an embodiment of the invention as shown in FIG. 1, a male component 120 is provided and being referenced to that of a plug. Said component 120 has a first end that comprises housing 50 and a second end engaged to a portion of a first light string 150. Housing 50 is shown as cylindrical but is not limited to a particular geometry, so long as a portion thereof is capable of entering an internal area or opening 85 formed within the female component 110. The male component 120 further comprises neck 45 that is the intermediary between electrical wires (not shown) and pin 70 and which may provide as guide for cap 40, which may be slidingly engaged thereto. Male component 120 and female component 110 may be comprised substantially of a non-electrical conductive material such as plastic, or an insulated material otherwise, and may be formed by processes not limited to molding, 3-D printing, boring, and or other known means.

Collar 10 is disposed around a periphery of the male component 120. As show in FIG. 1, collar 10 is located distal to housing 50, distal to the first end of the male component 120, and proximal to said neck 45. The location of collar 10 may however be located in other areas about the male component 120, so long as it serves as a stop for cap 40 and or provides housing for o-ring 80, which may include any deformable material capable of preventing passage of unwanted material. While only a single collar 10 is provided, it is within the scope of the invention that there be multiple collars, for example, a collar may be disposed about the second end of said male component 120 (i.e., distal to neck 45) and used to act as a stop for cap 40 and a second collar may be disposed proximal thereto (i.e. closer to the first end of said male component 120) and house o-ring 80.

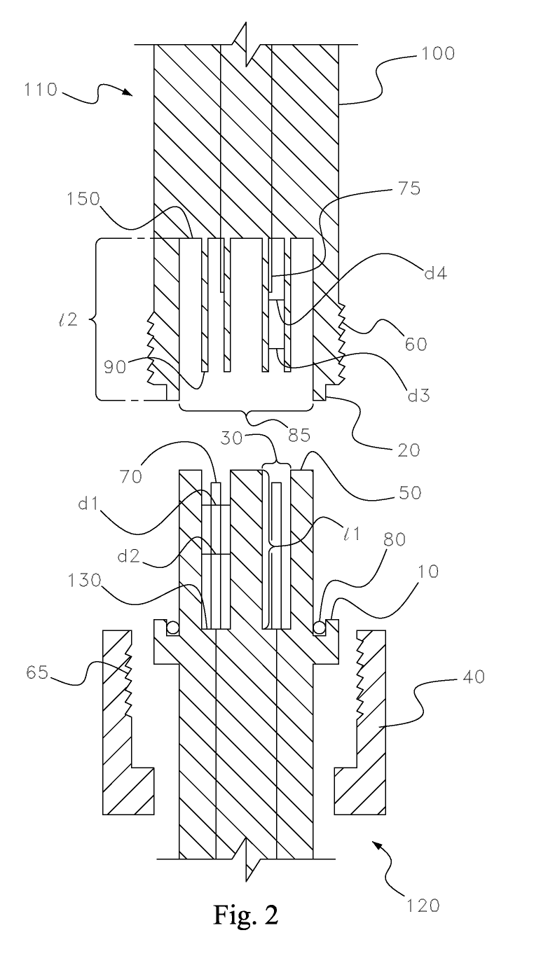

Extending in a proximal direction from collar 10 is housing 50 located at about the first end of male component 120. As shown, housing 50 comprises two holes 30 extending distal from its opening and having a depth, l_{I}. As provided in FIG. 2, holes 30 encase male electrical connections 70 recessed therein and referred to as pin, which may originate and or extend from base 130 of hole 30 and have a length equal to about l₁. The length of pins 30 may be equal or askew to each depending on configuration of a corresponding receptor 90 to be explained further. The length of pin 30 may be in the range of greater than 0.01l₁ to about l₁. As shown in FIG. 2, length of pins 30 is about equal to each and about 0.90l₁. Said pin 70 is designed to communicate an electrical charge between said male component 120 and female component 110 when in contact with (or sufficient proximity to) female contact 75.

Female component 110 has an opening 85 defined by rim 20 located at a first, proximal end of the female component 110, and is connected to a second light rope 160 at its second end. Said opening 85 leads to an internal area formed within the female component 110 that extends therein (i.e., distal) and is further defined by base 150 and at least one wall that has a length, l₂, as measured from proximal end of rim 20 to base 150. The female component 110, which could be referred to as a socket, further comprises an outer shell consisting of threading 60 disposed on a portion of an exterior surface. As shown, threading 60 is in a location proximal to a smooth region 100 and distal to said rim 20.

As shown, rim 20 forms a perimeter about opening 85. Said opening 85 is shaped and sized to accept housing 50. Extending out and or in a proximal direction from base 150 is a conduit and or sheath 90. The length of the conduit 90 may be about less than or equal to l₂. As shown in FIG. 2, length of sheath 90 is about 0.85l₂. Sheath 90 houses and or is formed around female electrical connection 75 and provides protection to said connection as well as a guide for pin 70. Sheath 90 has a diameter d₃ proximal to diameter d₄. And, hole 30 has a diameter d₁ proximal to diameter d₂. In an embodiment, d₃ is greater than d₁ but less than d₂ such that when sheath 90 enters hole 30 the proximal end 95 of sheath 90 can frictionally engage with an interior wall of hole 30 and act as a barrier to passage of unwanted material, for example water. In this embodiment, sheath 90 may comprise a deformable material, at least at its proximal end 95.

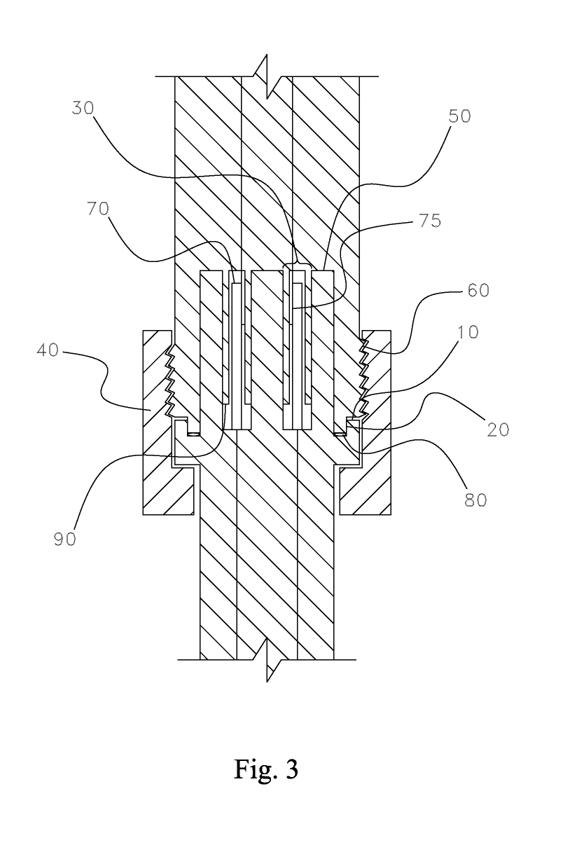

FIG. 3 is a cross sectional view of the assembly showing the engagement between the male 120 and female 110 connectors. As shown, sheath 90 surrounds pin 70 which is in electrical communication with female contact 75. Cap 40 internal threading is combined with threads 60. In practice, when cap 40 is tightened thereto extension 20 compresses o-ring 80 preventing passage of unwanted materials such as liquid and or gas. As shown, when the male component 120 and female component 110 are engaged and or connected, and cap 40 threads to 60, rim 20 is drawn to o-ring 80. When cap 40 is tightened and or secured thereto, rim 20 causes o-ring 80 it to deform and fill void therein to prevent passage of unwanted materials such as liquid and or gas. The interaction further acts as an airtight and or waterproof barrier therein.

1. A waterproof light rope assembly comprising:
a male component having two openings formed at a proximal end extending distal into said male component, wherein said openings each house a portion of an electrical conducting pin; and
a female component having an opening at a proximal end, consisting of an outward extension surrounding said opening and an internal area formed therein defined by a base, wherein two sheaths extend from said base and house a portion of an electrical contact designed to communicate with the electrical conducting pins.

2. The assembly of claim 1 further comprising a cap sliding engaged with a portion of said male component, and configured to secure said male component to said female component when joined.

3. The assembly of claim 2 further comprising a collar disposed about a periphery of said male component, distal to its proximal end, wherein the collar is indented in order to accept said outward extension of said female component such that the assembly is waterproof.

4. (canceled)

5. A waterproof light rope assembly comprising:
a female connector having an internal area defined by a rim disposed about an opening at one end and an internal base opposite said opening;
two conduits extending from said base of the female connector that each contain a portion of an electrical contact;
two electrical conducting pins each recessed within a male connector, wherein each conducting pin is accessible by an opening formed on an end of said male connector;
a collar disposed about said male connector that is shaped and sized to accept said rim of said female connector such that the assembly is waterproof; and
wherein said conduits are sized and shaped to enter corresponding openings formed on each male connector, and enter a sufficient distance such that is the pins are in sufficient proximity to the electrical contacts.

6. The assembly of claim 5 wherein when said pins are in sufficient proximity to an electrical contact a portion of said male portion is within said internal area defined by said female connector.

7. The assembly of claim 5 further comprising a cap that connects said male connector and said female connector.

8. The assembly of claim 5 wherein said male connector comprises an o-ring disposed about a periphery that is contacted by said rim to prevent passage of unwanted material.

9. (canceled)

10. The assembly of claim 8, wherein said cap comprises internal threading that corresponds to threading formed about an exterior surface of said female component, such that when the male and female components are joined, the cap may be tighten to secure said connection.

11. (canceled)

12. A waterproof light rope assembly comprising:
a male connector having a first end that has at least one hole opening formed thereon that extends distally into said first end and houses an electrical conducting pin, and a second end engaged to a portion of a first light string;
a female connector having a rim that defines an opening at a first end forming an internal area defined by an internal base therein, and a second end engaged to a portion of a second light string; and
a sheath encasing an electrical contact, disposed within said internal area, and extending from said base towards the opening.

13. The assembly of claim 12 further wherein said first end of said female connector is sized and shaped to accept said male connector and provide transmission of an electrical charge therebetween.

14. The assembly of claim 12 wherein the sheath has an opening that has a diameter less than the diameter of the hole opening such that the sheath may pass therethrough and surround the pin disposed therein, while joining the pin to the electrical contact.

15. The assembly of claim 14 wherein the diameter of the sheath opening is greater than a diameter of the hole distal to the opening of the hole such that wall of the sheath opening may frictionally engage with internal wall of the hole preventing passage of unwanted material.

16. The assembly of claim 12 further comprising:
a cap slidingly engaged to said male connector and configured to secure the male and female connector when joined;
a collar disposed around a periphery of the male connector distal to the first end of the male connector that serves as a stop for the cap.

17. The assembly of claim 16 wherein an o-ring is disposed about said collar, such that when the male and female components are combined the o-ring is contacted by said rim which deforms the o-ring and prevents passing of unwanted material therethrough.
